(19) United States
(12) Patent Application Publication
(10) Pub. No.: US 2026/0225188 A1
(43) Pub. Date: Aug. 6, 2026

(54) SYSTEMS AND METHODS FOR LASER DRILLING HOLES IN A SUBSTRATE

(71) Applicant: The Boeing Company, Arlington, VA (US)

(72) Inventors: Dane Richard Flammond, Seattle, WA (US); Megan Darlene Taylor, Seattle, WA (US); Matthew Carl Johnson, Auburn, WA (US); Sohail Joseph Nassiri, Auburn, WA (US); Alexander Anthony Hicker, Kent, WA (US); Marc James Froning, Seattle, WA (US)

(21) Appl. No.: 19/047,356

(22) Filed: Feb. 6, 2025

(51) Int. Cl. B23K 26/382; B23K 26/402

(52) U.S. Cl. CPC B23K 26/382; B23K 26/402

(57) ABSTRACT

In one example, a method for drilling holes in a substrate is presented. The method comprises focusing a laser relative to a surface of the substrate at a first drilling location in the substrate. The laser is applied to the surface of the substrate for a first drilling round, the first drilling round comprising one or more drilling passes wherein the laser is moved in x and y dimensions in a predetermined pattern. A focal plane of the laser is adjusted relative to the surface of the substrate in the z dimension. The laser is applied to the surface of the substrate at the first drilling location for a second drilling round, the second drilling round comprising one or more drilling passes wherein the laser is moved in x and y dimensions in the predetermined pattern.

### FIELD

The present disclosure generally relates to acoustic treatments for reducing noise in aircraft, and in particular to generating a perforated structure that can be used for an acoustic lining.

### BACKGROUND

Jet engines produce significant noise during takeoff and flight. This creates noise pollution, especially noticeable in highly populated areas. Many airports have their own noise regulations in addition to standards set by the Federal Aviation Administration (FAA) and International Civil Aviation Organization (ICAO) for acceptable noise levels produced by aircraft. The largest sources of noise in a jet engine are the fan/compressor, turbine, and the interaction between the exhaust and the surrounding atmosphere.

Currently, mechanical drilling is used to create perforations in the engine liner materials. However, there are several drawbacks to using known methods. Herein is described solutions to such issues using pulsed lasers to perform drilling for a variety of pore or hole sizes.

### SUMMARY

In one example, a method for drilling holes in a substrate is presented. The method comprises focusing a laser relative to a surface of the substrate at a first drilling location in the substrate. The laser is applied to the surface of the substrate for a first drilling round, the first drilling round comprising one or more drilling passes wherein the laser is moved in x and y dimensions in a predetermined pattern. A focal plane of the laser is adjusted relative to the surface of the substrate in the z dimension. The laser is applied to the surface of the substrate at the first drilling location for a second drilling round, the second drilling round comprising one or more drilling passes wherein the laser is moved in x and y dimensions in the predetermined pattern.

This Summary is provided in order to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any disadvantages noted in any part of this disclosure.

### BRIEF DESCRIPTION OF THE DRAWINGS

FIG. 1 illustrates an aircraft having an acoustic liner in an engine nacelle.

FIG. 2 schematically shows an example laser drilling system.

FIG. 3 schematically shows an example laser system that may be employed in some examples of FIG. 2.

FIG. 4 schematically shows an example focusing optics system that may be employed in some examples of FIGS. 2 and 3.

FIG. 5 shows a flow chart for an example method of drilling holes in a substrate.

FIGS. 6A-6G show example predetermined drilling patterns.

FIG. 7 illustrates an example distributed drilling scheme comprising a rectangular array.

FIG. 8A illustrates an example distributed drilling scheme comprising a hexagonal array.

FIG. 8B illustrates an example warped hexagon tiling strategy for a three-dimensional substrate.

FIG. 8C illustrates an example of warping hexagons to cover a three-dimensional geometry.

FIG. 9 schematically shows aspects of an example computing system.

### DETAILED DESCRIPTION

Aircraft engines produce noise primarily due to rotating blades that compress the airflow, rotating blades that extract energy from the airflow, and high-speed airflow through exhaust nozzles. To reduce noise and satisfy noise regulations governing commercial aircraft, aircraft engines may incorporate acoustic liners in various parts of the engine, such as in nacelle inlets as well as in aft bypass ducts and primary nozzles. The acoustic liners, sometimes referred to as acoustic treatments, acoustic panels, or Helmholtz resonator cavities, may comprise a honeycomb core sandwiched between a perforated inner skin and a non-perforated outer skin. The acoustic liners absorb acoustic noise and convert the acoustic energy to heat energy. The size of the perforations and the open area percentage of the lining impact the sound absorption coefficient and the range of absorbed frequencies, allowing for tailoring of the acoustic lining to match desired acoustic attenuation.

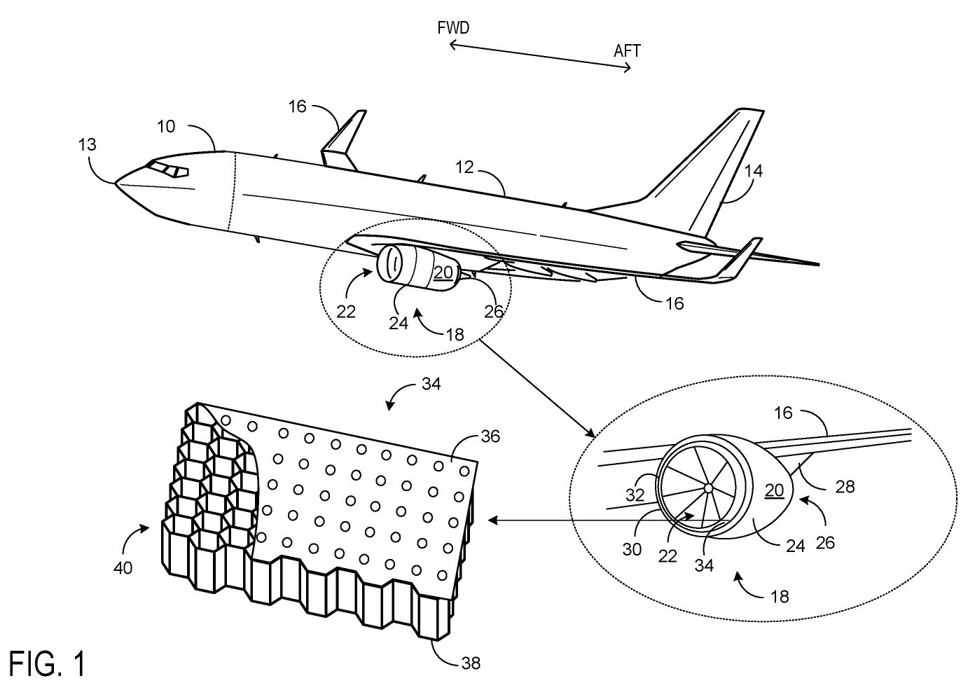

FIG. 1 is a perspective illustration of an aircraft 10 in which acoustic liners in accordance with the present disclosure may be implemented. The aircraft 10 may include a fuselage 12 extending from a nose 13 to an empennage 14. The empennage 14 may include one or more tail surfaces for directional control of the aircraft 10. The aircraft 10 may further include a pair of wings 16 extending outwardly from the fuselage 12. The aircraft 10 may include one or more propulsion units which, in an embodiment, may be supported by the wings 16. Each one of the propulsion units may be configured as a gas turbine engine 18 having a core engine (not shown) surrounded by a nacelle 20. The nacelle 20 may include an engine inlet 22 and a fan cowl 24 surrounding one or more fans (not shown) mounted on a forward end of the core engine. The nacelle 20 may have an exhaust nozzle 26 (e.g., a primary exhaust nozzle and a fan nozzle) at an aft end of the gas turbine engine 18.

As shown in the right-hand inset, gas turbine engine 18 is mounted on the corresponding wing 16 by a pylon 28. The engine inlet 22 may include a leading edge 30 and an inner barrel section 32 located aft of the leading edge 30 of the engine inlet 22. The inner barrel section 32 may provide a boundary surface or wall for directing airflow entering the engine inlet 22 and passing through the gas turbine engine 18. The inner barrel section 32 may be located in relatively close proximity to fans of the core engine. In this regard, the inner barrel section 32 may also be configured with an acoustic liner or panel 34 (shown in cutaway detail in the left-hand inset). Acoustic panel 34 comprises a perforated inner face sheet 36 and a non-perforated outer face sheet 38 sandwiched around a sound-attenuating honeycomb core 40. Acoustic panel 34 absorbs noise generated by the rotating fans and/or noise generated by the airflow entering the engine inlet 22 and passing through the gas turbine engine 18.

Perforated inner face sheet 36 and non-perforated outer face sheet 38 may comprise a polymer such as a carbon-fiber reinforced polymer (CFRP). The CFRP may be a composite with a thermoset resin such as epoxy, or other thermoset or thermoplastic polymers such as polyester, vinyl ester, nylon or the like used as a binding polymer. The CFRP composites may include other materials in addition to the carbon fibers, such as steel, ceramics, graphite, fiberglass, aramids such as Kevlar and Twaron, aluminum and the like, to achieve desired strength, stiffness, weight and other material properties when cured. Perforated inner face sheet 36 and non-perforated outer face sheet 38 may be securely bonded to opposite sides of honeycomb core 40, such as via adhesive sheets.

Sound-attenuating honeycomb core 40 is formed from a multiplicity of core cells. Although shown as having a hexagonal cross-sectional shape, other shapes for the core cells of honeycomb core 40 are possible. To facilitate sound attenuation, the core cells of honeycomb core 40 are placed in fluid communication with the ambient atmosphere proximate perforated inner face sheet 36 and, correspondingly, an airflow over the outer surface of perforated inner face sheet 36. Perforated inner face sheet 36 has a plurality of face sheet apertures extending through perforated inner face sheet 36 and arranged in a two-dimensional pattern across perforated inner face sheet 36 to expose substantially all of the core cells of honeycomb core 40 to the airflow. Although shown as circular holes of a single size, perforations in perforated inner face sheet may be any suitable shape (e.g., slots, triangles, squares, hexagons, etc.) and combination of sizes to accomplish a desired acoustic attenuation profile.

Currently, perforations in engine acoustic liner materials like CFRP are created using mechanical drilling. However, polymers such as CFRP are highly heat sensitive. Thermal buildup due to mechanical drilling may lead to quickly exceeding the combustion and heat-induced damage tolerance thresholds of the material. As such, there are several limitations to mechanical drilling including matrix cracking, fiber pull-outs, delamination, tool wear (thus requiring frequent replacement thereof), thermal degradation, excessive dust, and poor surface quality. Additionally, mechanical drilling can limit the diameter of holes (consistently ~0.020” or greater) that can be made due to the inadequate strength of micro drilling bits compared with the force necessary to perform the drilling action.

Herein, systems and methods are provided for laser-drilling a substrate, wherein a combination of techniques may be applied that serve to generate high quality holes with few size restrictions. The drilling process involves tailoring the number of passes, velocity, and laser power for proper dosage per each hole size. This results in a relatively small heat affected zone, minimal taper, and acceptable acoustic performance.

Holes may be drilled in an array on the substrate in the X and Y dimensions. A third axis micro-adjustment device is integrated into the laser system to step the laser’s focal plane into the substrate during the drilling process. Such Z-stepping allows for maintaining high energy density at the focal point. For CFRP substrates, in embodiments, an ultrashort pulsed (e.g., 7 picosecond) green (e.g., 532nm) laser can be used to complete hole drilling tasks, matching the absorptivity of the polymer to the laser, and allowing for drilling smaller holes in a more efficient manner with acceptable acoustic performance. Methods of layering specific circular geometries in drilling patterns may be used to produce a variety of hole shapes and sizes of high quality. A distributed drilling technique may be applied to disperse heat and reduce thermal degradation on the substrate surface.

Using the disclosed systems and methods, there are virtually no hole size limitations and fewer tooling costs as opposed to a mechanical drilling process which requires specific bit sizes and frequent tool replacement. The disclosed systems and methods can thus be used to increase engine noise damping by creating a larger array of hole size and orientation options and reduce manufacturing costs and byproducts from mechanical drilling. For example, holes must be deburred after mechanical drilling which is a process not necessary with laser drilled holes. Removing this step also removes the ergonomic risk associated with deburring.

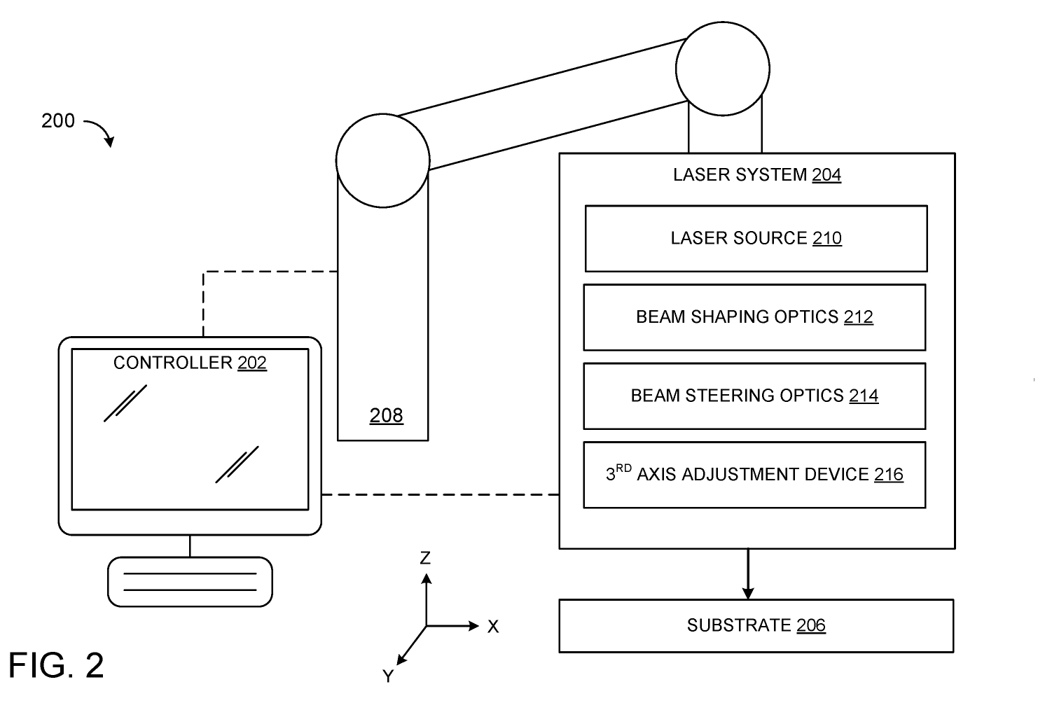

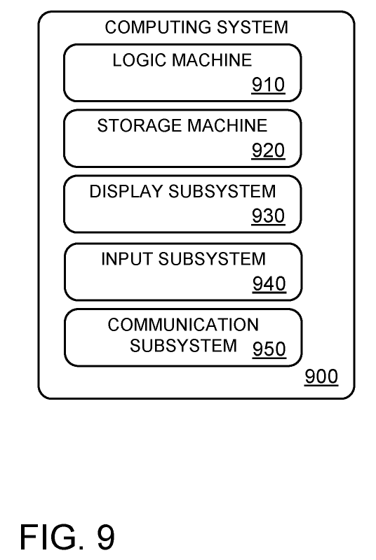

FIG. 2 schematically shows an example laser drilling system 200. Laser drilling system 200 comprises a controller 202 which operates a laser system 204 to drill holes in a substrate 206. Herein, substrate 206 is generally described as being a carbon fiber reinforced polymer substrate, but other substrate types may be used in some examples. Controller 202 may operate a manipulator 208, such as a robotic arm or other suitable positioner. Manipulator 208 may be operated to provide gross positioning of laser system 204 relative to substrate 206 in 3 dimensions. In some examples, a single controller, or separate controllers can be utilized to operate manipulator 208 and laser system 204. However, each controller may be communicatively coupled to a computing device, such as a programmable logic controller in order to coordinate operations of manipulator 208 and laser system 204. An example computing system is described further herein and with regard to FIG. 9.

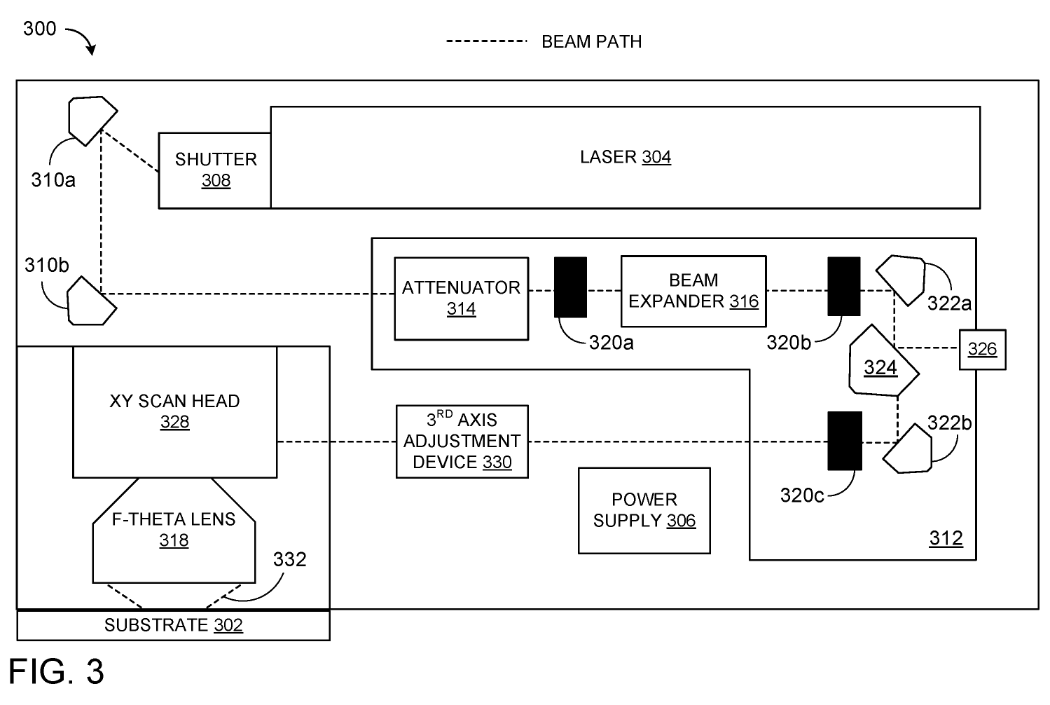

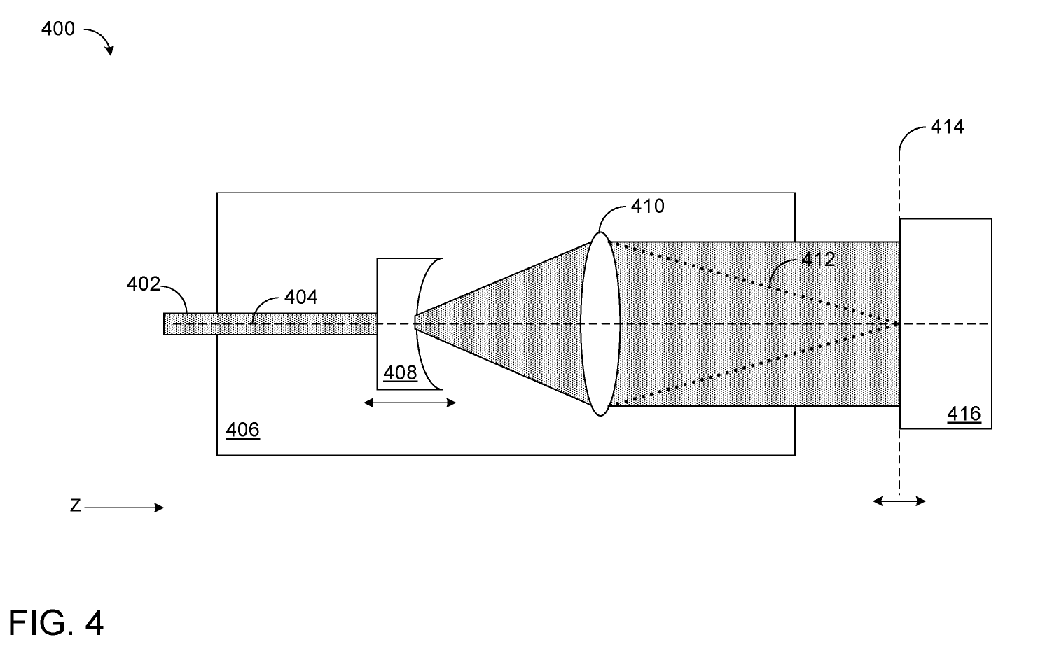

Laser system 204 comprises at least a laser source 210, beam shaping optics 212, beam steering optics 214, and 3^{rd} axis adjustment device 216. Specific example configurations for beam shaping optics, beam steering optics, and 3^{rd} axis adjustment devices are described further herein and with regard to FIGS. 3 and 4. Controller 202 may direct laser source 210 to emit a laser beam (e.g., a pulsed or continuous laser beam) along a laser beam path on an optical axis, and then coordinates the motions of the beam steering optics and the 3^{rd} axis adjustment device to cause the laser beam path and hence the laser pulses to intersect substrate 206 at the desired location(s) at the desired time.

Beam shaping optics 212 may be operated to configure the size and shape of the laser beam in both temporal and spatial aspects. As an example, temporal modification of the laser beam may be accomplished by optical devices such as acousto-optic modulators or electro-optic modulators in conjunction with other optical elements such as polarizers that can slice the beam to change the beam shape or deflect the beam to prevent it from reaching the workpiece. The beam can also undergo spatial modifications including collimation, where the beam is shaped to provide optical propagation along rays parallel to the laser beam path, beam shaping by conventional or diffractive optics to create a desired beam cross section and/or apertures to shape the limits of the beam, along with more conventional lenses which create the desired spot size on the substrate.

Beam steering optics 214 may comprise at least an XY-Scan head configured to position the laser source in the X and Y dimensions relative to substrate 206. Beam steering optics 214 may be implemented with galvanometers or other beam steering devices such as piezo-electric or voice coil steered mirrors function to position the laser beam path in relation to substrate 206 in order to drill the holes in the proper position(s). Beam steering optics 214 may be operable to position the laser beam path within a working window of the laser. Movements of the laser beam path over larger distances in the X and Y dimensions, such as movement between working windows may be enacted by operation of manipulator 208. 3^{rd} axis adjustment device 216 may be configured to adjust a focal plane of the laser relative to the surface of substrate 206 in the z dimension. Gross movement of the laser relative to the surface of substrate 206 may be enacted by operation of manipulator 208.

FIG. 3 shows an example laser system 300. Laser system 300 may be an example of laser system 204. Laser system 300 may be configured for drilling holes in substrate 302, which may be an example of substrate 206. Laser system 300 includes laser 304, which may be an example of laser source 210 (see, FIG. 2). As an example, laser 304 may be a solid-state laser that uses a crystal (e.g., Neodymium doped YVO₄, YAG, or YLF). Laser 304 may be operated at a suitable wattage for drilling holes in substrate 302 (e.g., 30W-100W). Laser 304 may be a continuous beam laser or a pulsed laser, such as a pulsed laser having a pulse energy of at least 1.0 microJoule per pulse. Such lasers typically produce pulses with wavelengths in the infrared region of the spectrum, typically ranging from 1.0 microns to 1.3 microns. These pulses are then subjected to frequency conversion, a process by which the laser pulse passes through one or more frequency doubling crystals to produce wavelengths ranging from green, which is approximately 550nm to ultraviolet, in the range from 255 to 365 run. In addition, any one of a number of lasers operating at a variety of wavelengths could be used advantageously with this process, including CO₂ or other gas lasers operating in the infrared region of the spectrum or any one of a number of fiber lasers. In the example wherein substrate 302 is a CFRP substrate, laser 304 may be a green laser, such as a 532nm laser. When laser 304 is configured as a pulsed laser, laser 304 may operate with a pulse-width less than 10 picoseconds, for example, less than about 8ps, or less than about 7ps. Laser 304 may comprise two or more apertures, such that drilling locations in substrate 302 comprise two or more drilling sites. Laser 304 and other active components of laser system 300 may be powered by power supply 306.

Laser system 300 may comprise a shutter 308 that restricts the light output by laser 304. Shutter 308 may act as a mechanical blockage to prevent undesirable frequencies of light from entering the optics of laser system 300. A laser beam (shown as a dashed line) may exit shutter 308 and reflect off of reflective optics 310a and 310b towards beam shaping optics 312. For example, reflective optics 310a and 310b may be folding mirrors, such as an X-axis mirror and a Y-axis mirror.

Beam shaping optics 312 includes attenuator 314. Attenuator 314 may be operated to control and/or ratio the power output of laser 304. For example, attenuator 314 may comprise a pair of phase plates, the angles of which may be adjusted relative to the beam path and to each other.

Beam shaping optics 312 further includes a beam expander 316. The beam expander 316 has an expansion ratio that alters the size of a laser beam of the laser output. A ratio greater than unity is to represent a beam of the laser output that at the output of the expander, has a dimension (e.g., a diameter or major axis length) that is larger than the dimension at the expander input. An expansion ratio of less than one results in a reduced beam dimension. Generally, the beam expansion ratio will be chosen to provide a certain spot size at the surface of substrate 302. The spot size relates to the focal length and diameter of the beam at the output focusing optics, which may include an F-theta lens 318 for scanning. Commercially available off the shelf beam expanders are generally designed for on-axis operation. The design of the beam expander 316 may include consideration of aberrations associated with the beam size and maximum angle of an incident laser beam.

Beam shaping optics 312 further includes transmissive optics 320a, 320b, and 320c, which may comprise alignment features that ensure the beam path is traversing beam shaping optics 312 as desired. Beam shaping optics 312 further include reflective optics 322a and 322b (e.g., folding mirrors, such as an X-axis mirror and a Y-axis mirror). A beam splitter 324 is shown optically between reflective optics 322a and 322b. Beam splitter 324 may divert a portion (e.g., 5%) of the laser beam to power meter 326.

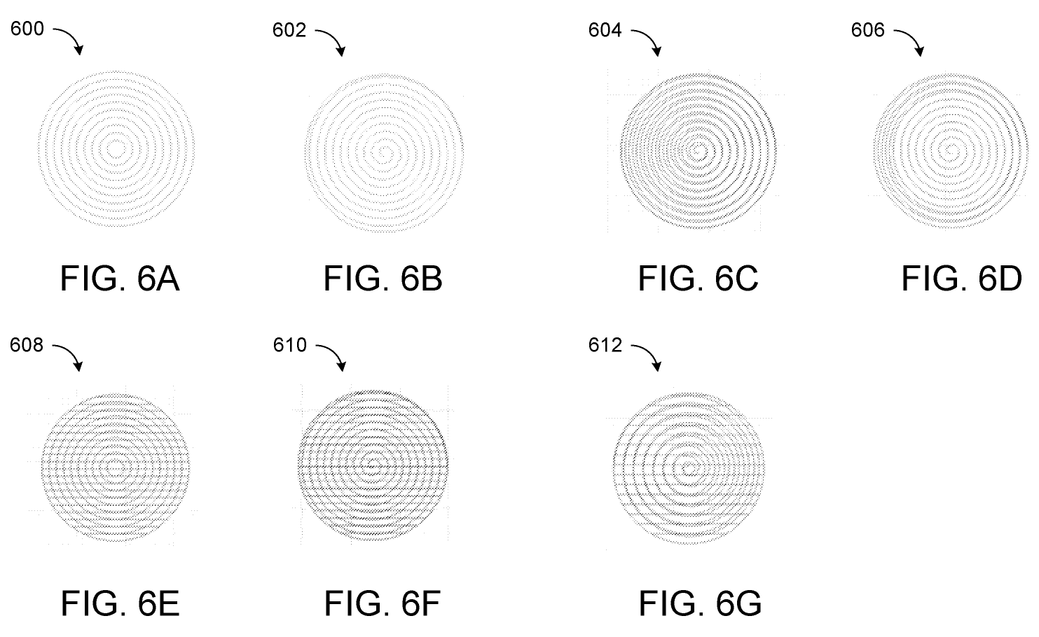

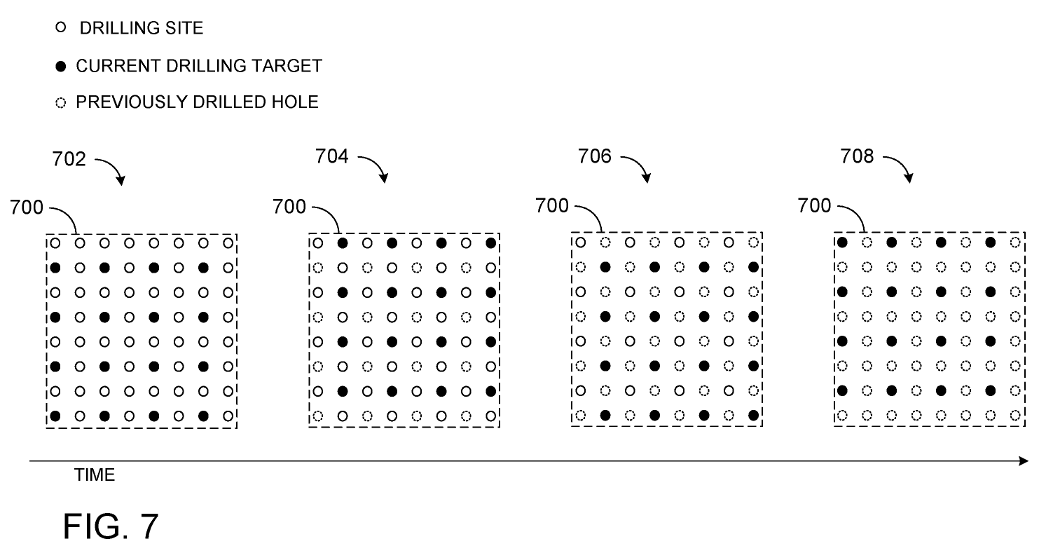

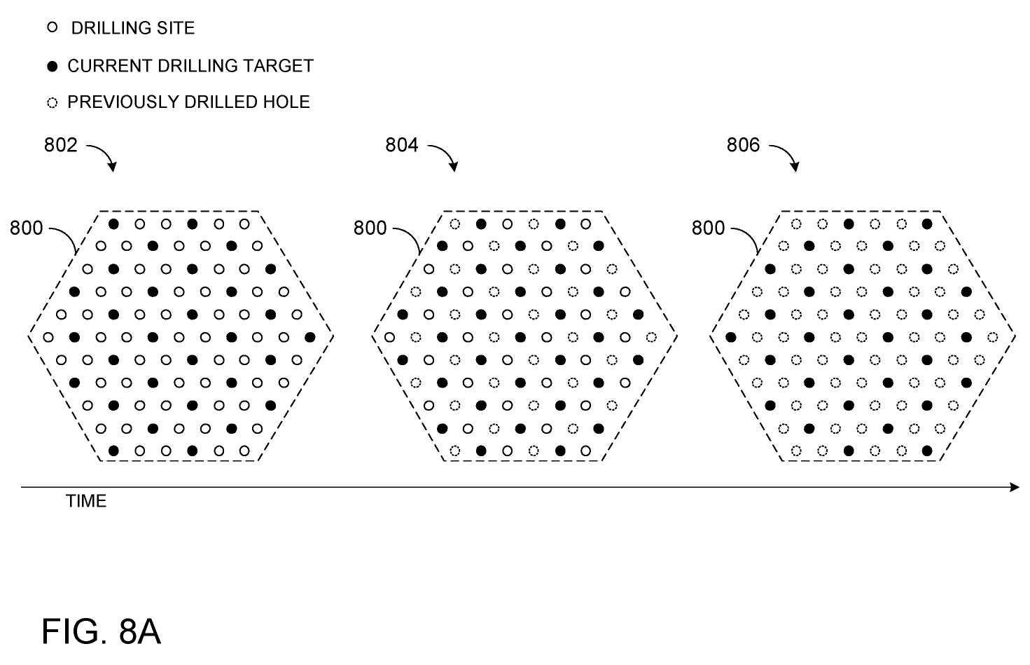

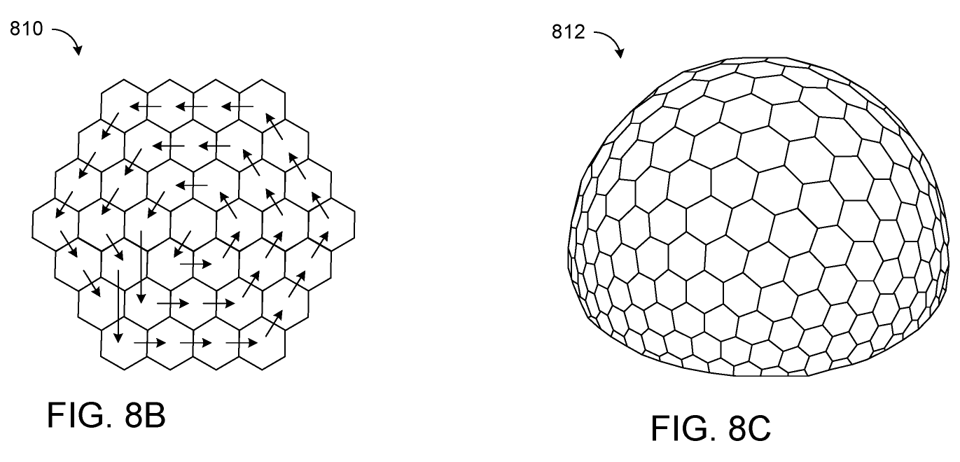

A laser beam exiting beam shaping optics 312 is directed to XY scan head 328 via 3^{rd} axis adjustment device 330. 3^{rd} axis adjustment device 330 may be configured to adjust a focal plane of the output beam 332 relative to the surface of substrate 302 in the z dimension. 3^{rd} axis adjustment device 330 is an example of 3^{rd} axis adjustment device 216. An example is described herein and with regard to FIG. 4. XY scan head 328 is an example of beam steering optics 214. XY scan head 328 may be operated to control the motion of output beam 332 in the X and Y dimensions relative to substrate 302. XY scan head 328 may be used to control microscale motion (e.g., within a few microns, for example, 1-3 microns) such as carving out predetermined drilling patterns, as will be described with regard to FIGS. 6A-6G. XY scan head 328 may be further used to control mesoscale motions of output beam 332 (e.g., within a working window), such as migrating between drilling locations in a distributed pattern, such as will be described herein with regard to FIGS. 7 and 8A. Macroscale motion of output beam 332 may be enacted by a manipulator (e.g., manipulator 208) that moves laser system 300 as a whole.

F-theta lens 318 may be a fixed position lens optically following XY scan head 328. F-theta lens 318 may operate to focus output beam 332 to a spot or other shape at substrate 302. Advantageously, F-theta lens 318 allows for a substantially constant spot size at any location within the scan field. F-theta lens 318 may be UV-coated and can be engaged to an output end of XY scan head 328. F-theta lenses are available in different sizes and may be selected to achieve a desired spot size on the surface of substrate 302. F-theta lens 318 may be used in combination with beam expander 316 to increase or decrease the spot size.

FIG. 4 shows an example focusing optics system 400. A laser beam 402 centered around optical axis 404 (dashed line) enters focusing optics 406. For example, laser beam 402 may be an example of the laser beam that is output from beam shaping optics 312. Focusing optics 406 comprises moving optics 408 and fixed optics 410. Moving optics 408 may be an example of 3^{rd} axis adjustment devices 216 and 330. Fixed optics 410 may be an example of F-theta lens 318. In this example, moving optics 408 is configured as a plano-concave lens and fixed optics 410 is configured as a double convex lens, although other optical configurations are possible. A shaped beam 412 (dotted lines) exits fixed optics 410 and is focused on a focal plane 414 relative to a surface of substrate 416.

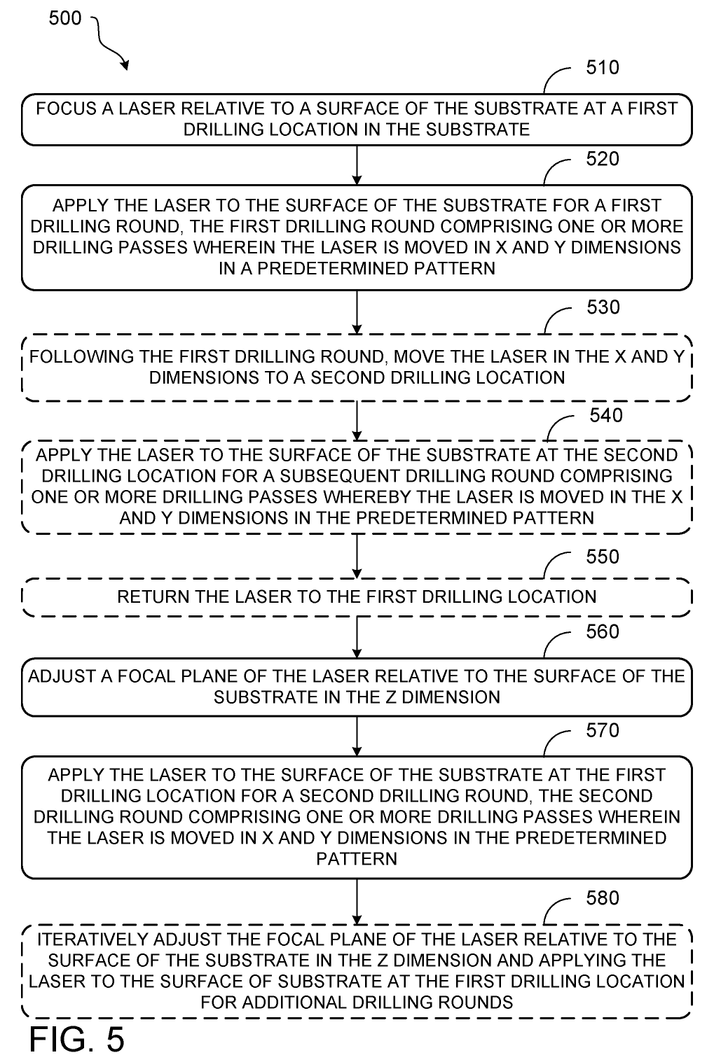

By adjusting the position of moving optics 408, focal plane 414 may be moved along the optical (z) axis 404. For example, movement of moving optics 408 may be sufficient to adjust focal plane 414 by 5mm in either direction. This may be used to move the focal plane below the surface of substrate 416 in between drilling passes to enhance the drilling process, similar to how the tip of a mechanical drill is moved into a workpiece as drilling proceeds. For example, the surface of substrate 416 may be ablated for a duration, then moving optics 408 adjusted to move focal plane 414 so that shaped beam 412 drills further into substrate 416. As described herein and with regard to FIG. 5, this process may be iterated, gradually drilling further into substrate 416. By adjusting moving optics 408, focusing optics 406 thus keeps the active surface of substrate 416 in focus, leading to higher quality holes.

FIG. 5 shows a flow-diagram for an example method 500 for drilling holes in a substrate with a laser. Method 500 may be implemented via a controller (e.g., controller 202) communicatively coupled to a laser system (e.g., laser system 204) that comprises a third axis adjustment device (e.g., 3^{rd} axis adjustment device 216).

At 510, method 500 includes focusing a laser relative to a surface of the substrate at a first drilling location in the substrate. For example, the laser source may be grossly positioned relative to the substrate in the Z dimension by a manipulator (e.g., manipulator 208). The 3^{rd} axis adjustment device (e.g., 3^{rd} axis adjustment device 216, 330, moving optics 408) may then be adjusted to place the focal plane of the laser at the surface of the substrate. Other beam optics may be manipulated accordingly to generate the desired beam shape and size at the first drilling location.

The laser may be a continuous beam or a pulsed laser. The wavelength of the laser may be matched to the absorptivity of the substrate. In some examples, the substrate is carbon fiber reinforced polymer. In such examples, the laser can be a green laser, such as a 532nm laser. To reduce thermal damage at the operating power, the laser may be a pulsed laser, with a pulse duration that is shorter than the heat transfer regime for the substrate. For example, the laser may be a pulsed laser having a pulse-width (e.g., pulse duration) of less than 10 picoseconds. In some examples, the laser optics may be configured so that there are two or more apertures. As such, the first drilling location may comprise multiple drilling sites separated in the X and Y dimensions across the surface of the substrate. The manipulator (e.g., manipulator 208) and/or beam steering optics (e.g., XY scan head 328) may be utilized to position the laser aperture(s) at the first drilling location.

At 520, method 500 includes applying the laser to the surface of the substrate for a first drilling round, the first drilling round comprising one or more drilling passes wherein the laser is moved in x and y dimensions in a predetermined pattern. Each drilling pass may comprise on the order of thousands of picosecond-duration laser pulses. Each drilling pass may repeat the same predetermined pattern, or the combination of drilling passes may generate a single predetermined pattern. As a non-limiting example, the first drilling round may comprise ten drilling passes.

Based on the wavelength of the laser and the absorptivity of the substrate, the majority of the energy being absorbed by the substrate is being absorbed at the surface of the material. The laser acts to perform photo-ablation, whereby the molecular bonds of the substrate are ripped apart, even though the laser does not penetrate deep into the substrate. In this way, the laser may be operated at a high fluence or energy density over a drilling pass.

For very small holes (e.g., roughly the diameter of the output laser beam), the predetermined pattern may be a single point having minimal movement in the X and Y dimensions, whereby the laser is operated in a percussive drill mode. For larger holes, the predetermined pattern may result in a perforation with any suitable size and shape based on the desired acoustic properties of the final perforated substrate. Perforations may be realized on the order of 0.120” or smaller, such as from 0.001” to 0.02”, or from 0.001” to 0.047”, or from 0.001” to 0.08”, or from 0.001” to 0.120”, but may be larger in some examples, e.g., using laser cutting techniques. As non-limiting examples, the predetermined pattern may yield perforations that are circular, elliptical, squares, triangles, hexagons, rectangles, slots, etc. Herein, a number of predetermined patterns are described for drilling circular holes in a substrate, but one skilled in the art should recognize how these predetermined patterns could be translated to other cross-sectional shapes. In some example, the predetermined patterns can be machined at high angles of incidence to the surface plane of the substrate, rather than cut straight down through the material. As such, the predetermined pattern may yield tapered openings, which may be beneficial for acoustic or aerodynamic reasons.

For drilling with a pulsed laser, the XY scanner may be moved in a controller predetermined pattern in conjunction with the pulse rate. For example, one or more laser pulses may be fired, then the aperture moved along the predetermined pattern. In this way, a predetermined pattern may be executed within fractions of a second.

For drilling circular holes, the predetermined pattern may be a layered circular geometry, using techniques associated with trepan drilling of cored circles. In typical trepan drilling, the laser may be moved in the X and Y dimensions around the circumference of the desired circular hole. However, focusing the laser only on the perimeter of the hole may generate a heat effected zone resulting in burnt edges. As such, the predetermined pattern may remove material from the interior of the desired hole as well as the perimeter of the desired hole. In some examples, the predetermined pattern may be a raster pattern across the desired hole. In each of the described examples, the material removal rate may be increased over simple trepan boring. Each predetermined pattern may be repeated two or more times in a drilling round (e.g., multiple passes).

For example, FIG. 6A shows an example predetermined pattern 600 comprising concentric circles. FIG. 6B shows an example predetermined pattern 602 comprising a spiral pattern. In some examples, multiple spiral patterns may be overlayed (e.g., a clockwise spiral pattern overlayed with a counter-clockwise spiral pattern.) In some examples, the spiral pattern may begin at the perimeter of the desired hole and spiral to the center. In other examples, the spiral pattern may begin at the center of the desired hole and spiral outward to the perimeter.

FIG. 6C shows an example predetermined pattern 604 comprising a spiral pattern (e.g., predetermined pattern 602) overlayed with concentric circles from the outer perimeter of the desired hole to the center (e.g., predetermined pattern 600). Layering concentric circles on the spiral pattern may result in a cleaner removal rate without generating jagged edges at the entry point of the spiral on the hole perimeter. The spiral pattern removes most of the material, while the concentric circles clean the edges of the hole.

As an alternative to overlaying concentric circles for the entire hole diameter, FIG. 6D shows an example predetermined pattern 606 comprising a spiral pattern (e.g., predetermined pattern 602) overlayed with several concentric circles at the hole perimeter (e.g., not extending all the way to the hole center).

For smaller diameter circles, predetermined patterns 600-606 may result in misshapen circles. This may be combated by performing additional hatching as part of the predetermined pattern. FIG. 6E shows an example predetermined pattern 608 comprising concentric circles (e.g., predetermined pattern 600) overlayed with additional hatching. FIG. 6F shows an example predetermined pattern 610 comprising a spiral pattern (e.g., predetermined pattern 602) overlayed with additional hatching. FIG. 6G shows an example predetermined pattern 612 comprising a spiral pattern overlayed with concentric circles (e.g., predetermine pattern 604) overlayed with additional hatching. In another example, predetermined pattern 606 may be overlayed with additional hatching (not shown).

Returning to FIG. 5, optionally, at 530, method 500 includes following the first drilling round, moving the laser in the x and y dimensions to a second drilling location. Optionally, at 540, method 500 includes applying the laser to the surface of the substrate at the second drilling location for a subsequent drilling round comprising one or more drilling passes whereby the laser is moved in the x and y dimensions in the predetermined pattern.

Method 500 may thus employ a distributed drilling technique (e.g., interlaced drilling), where drilling is performed at two or more locations on the substrate surface. This technique will be described herein for lasers with multiple apertures, and thus where each drilling location comprises a plurality of drilling sites, but is should be understood that the distributed drilling technique can be applied to a series of two or more single-site drilling locations. The total number of drilling sites may be based on the desired total open area percentage of the substrate, the size of the desired holes, etc. These parameters will also inform the spacing between the drilling sites, so as to form a type of mesh in the substrate.

By iteratively drilling at two or more drilling locations on the substrate surface, the method allows for enough time to pass at each drilling site to allow that site to return to a temperature below a threshold (e.g., ambient temperature). Particularly for CFRP and other polymeric materials, the substrate has a low thermal threshold, and the carbon fiber in the substrate tends to conduct heat through the material. By interlacing multiple drilling locations, the thermal energy is distributed around the surface of the substrate, minimizing heat concentration at any given drilling site, and maintaining the substrate below a temperature threshold. By controlling which holes are drilled and in what order, drilling sites are allowed to rest in between passes, preventing heat buildup and material degradation. This in turn allows for faster completion of the drilling method in total, as additional drilling can occur while waiting for drilling sites to cool down following a set of drilling passes.

FIG. 7 shows an example distributed drilling technique comprising a square array 700. While shown as an 8x8 array 700 of drilling sites, the size of the array in many examples will be much larger. Therein, a set of drilling sites across the substrate are divided into four groups. At 702, a first group of drilling sites (e.g., a first drilling location) are targeted for drilling. At a second time point, at 704, a second group of drilling sites (e.g., a second drilling location) are targeted for drilling. At a third time point, at 706, a third group of drilling sites (e.g., a third drilling location) are targeted for drilling. At a fourth time point, at 708, a fourth group of drilling sites (e.g., a fourth drilling location) are targeted for drilling. Subsequently, the focal plane of the laser may be adjusted relative to the substrate surface, and the first group of drilling sites again targeted for drilling. The method iterates through the four drilling groups until the holes are drilled completely through the substrate.

In some examples, array 700 may be comprised within a working window for the laser system. As such, movement of the laser in the x and y dimensions across time points 702-708 may be performed using the beam steering device of the laser system (e.g., beam steering optics 214, XY scan head 328). To complete a larger area of hole drilling, the manipulator of the laser system (e.g., manipulator 208) may move the entire laser system to a new working window (e.g., adjacent to array 700) then repeat the distributed drilling process shown in FIG. 7. Different laser systems may comprise differently sized working windows, and thus may inform the grid size, number of arrays, and amount of times the manipulator is employed to move the laser system across the substrate.

Although shown as a square array with four groups, the distributed drilling technique may comprise any pattern of drilling sites (e.g., diamond, rectangle, triangle, hexagon), with fewer (e.g., 2 or 3) or more (e.g., 6) groups.

For example, FIG. 8A illustrates an example distributed drilling scheme comprising a hexagonal array 800. While shown as a hexagonal array 800 with 91 drilling sites, the size of the array in many examples will be much larger. Therein, a set of drilling sites across the substrate are divided into three groups. At 802, a first group of drilling sites (e.g., a first drilling location) are targeted for drilling. At a second time point, at 804, a second group of drilling sites (e.g., a second drilling location) are targeted for drilling. At a third time point, at 806, a third group of drilling sites (e.g., a third drilling location) are targeted for drilling. Subsequently, the focal plane of the laser may be adjusted relative to the substrate surface, and the first group of drilling sites again targeted for drilling. The method iterates through the three drilling groups until the holes are drilled completely through the substrate.

In some examples, array 800 may be comprised within a working window for the laser system. As such, movement of the laser in the x and y dimensions across time points 802-806 may be performed using the beam steering device of the laser system (e.g., beam steering optics 214, XY scan head 328). To complete a larger area of hole drilling, the manipulator of the laser system (e.g., manipulator 208) may move the entire laser system to a new working window (e.g., adjacent to array 800) then repeat the distributed drilling process shown in FIG. 8A. FIG. 8B illustrates an example tiling strategy 810 for an array of regular hexagons.

Hexagonal arrays may provide advantages when drilling substrates with complex geometries. Tiled hexagonal arrays can be established to cover large three-dimensional areas using hexagonal coordinate systems and wrapping algorithms. For example, FIG. 8B illustrates an example warped hexagon tiling strategy 812 for covering a three-dimensional substrate. Warped hexagon tiling strategy 812 utilizes a combination of regular hexagons (e.g., comprised of six equilateral triangles) and irregular hexagons (e.g., comprising six triangles with arbitrary dimensions) to cover a complex geometry.

Different drilling locations may have different predetermined drilling patterns. This may be performed to generate a perforated substrate with holes of multiple sizes and/or shapes, and thus increase the spectrum of acoustic frequencies that may be absorbed by the perforated substrate. Additionally, specific geometry patterns may also provide advantages in structural performance and/or create desired aesthetic effects.

As such, in some examples, method 500 includes iteratively moving the laser in the x and y dimensions to additional drilling locations, and applying the laser to the surface of the substrate at the additional drilling locations for subsequent drilling rounds comprising one or more drilling passes whereby the laser is moved in the x and y dimensions in the predetermined pattern.

Returning to FIG. 5, optionally, at 550, method 500 includes returning the laser to the first drilling location. At 560, method 500 includes adjusting a focal plane of the laser relative to the surface of the substrate in the z dimension. For example, the position of the 3^{rd} axis adjustment device (e.g., 3^{rd} axis adjustment device 216, 330, moving optics 408) may be adjusted to move the focal plane of the laser below the surface of the substrate. The amount of movement of the focal plane may be based on the amount of material removed in the first drilling round (e.g., 0.1mm).

At 570, method 500 includes applying the laser to the surface of the substrate at the first drilling location for a second drilling round, the second drilling round comprising one or more drilling passes wherein the laser is moved in x and y dimensions in the predetermined pattern.

The second drilling round may follow the first drilling round following a duration wherein a temperature at the first drilling location decreases below a threshold temperature. In this way, the highest possible energy density may be maintained for each drilling round. In some examples, this cooling down period may occur while the laser is being applied to the surface of the substrate at the second (or additional) drilling locations.

In some examples, the predetermined pattern may be a three-dimensional pattern, wherein the first drilling round and the second drilling round individually have different predetermined patterns in the x and y dimensions. For example, a spiral pattern may be cut in three dimensions, where some portions of the spiral (e.g., outer portions) are cut at a first depth, and other portions of the spiral (e.g., inner portions) are cut after the focal plane has been changed.

In examples where distributed drilling techniques are used, the method may be iterative, wherein a number of drilling passes are performed at the first drilling location at a first focal depth, than a number of drilling passes performed at the second drilling location at the first focal depth, with subsequent drilling passes at additional locations at the first focal depth. The focal plane of the laser relative to the substrate may then be adjusted in the x dimension, and drilling passes performed sequentially starting at the first drilling location. Method 500 may thus further include, following the second drilling round at the first drilling location, returning the laser to the second drilling location, and performing a second drilling round at the second drilling location. This may be iterated for additional drilling locations.

Optionally, at 580, method 500 includes iteratively adjusting the focal plane of the laser relative to the surface of the substrate in the z dimension and applying the laser to the surface of substrate at the first drilling location for additional drilling rounds. The number of drilling rounds depends on the thickness of the substrate and the material removal rate for each drilling round, as each pass of the laser removes a set amount of material. For example, if the substrate is 2mm thick, and each drilling round removes .025mm of material, 40 drilling rounds will be needed to bore a hole through the entirety of the substrate.

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 910 and a storage machine 920. Computing system 900 may optionally include a display subsystem 930, input subsystem 940, communication subsystem 950, and/or other components not shown in FIG. 9. Controller 200 is an example of computing system 900.

Logic machine 910 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 920 includes one or more physical devices configured to hold instructions executable by the logic machine to implement the methods and processes described herein. When such methods and processes are implemented, the state of storage machine 920 may be transformed—e.g., to hold different data.

Storage machine 920 may include removable and/or built-in devices. Storage machine 920 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 920 may include volatile, nonvolatile, dynamic, static, read/write, read-only, random-access, sequential-access, location-addressable, file-addressable, and/or content-addressable devices.

It will be appreciated that storage machine 920 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 910 and storage machine 920 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 910 executing instructions held by storage machine 920. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 930 may be used to present a visual representation of data held by storage machine 920. This visual representation may take the form of a graphical user interface (GUI). As the herein described methods and processes change the data held by the storage machine, and thus transform the state of the storage machine, the state of display subsystem 930 may likewise be transformed to visually represent changes in the underlying data. Display subsystem 930 may include one or more display devices utilizing virtually any type of technology. Such display devices may be combined with logic machine 910 and/or storage machine 920 in a shared enclosure, or such display devices may be peripheral display devices.

When included, input subsystem 940 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 950 may be configured to communicatively couple computing system 900 with one or more other computing devices. Communication subsystem 950 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

Further, the disclosure comprises configurations according to the following examples.

Example 1. A method for drilling holes in a substrate, the method comprising focusing a laser relative to a surface of the substrate at a first drilling location in the substrate; applying the laser to the surface of the substrate for a first drilling round, the first drilling round comprising one or more drilling passes wherein the laser is moved in x and y dimensions in a predetermined pattern; adjusting a focal plane of the laser relative to the surface of the substrate in a z dimension; and applying the laser to the surface of the substrate at the first drilling location for a second drilling round, the second drilling round comprising one or more drilling passes wherein the laser is moved in x and y dimensions in the predetermined pattern.

Example 2. The method of example 1, further comprising iteratively adjusting the focal plane of the laser relative to the surface of the substrate in the z dimension and applying the laser to the surface of substrate at the first drilling location for additional drilling rounds

Example 3. The method of examples 1-2, wherein the substrate comprises carbon fiber reinforced polymer and wherein the laser is a green laser.

Example 4. The method of examples 1-3, wherein the laser is a pulsed laser with a pulse-width of less than 10 picoseconds.

Example 5. The method of examples 1-4, wherein the predetermined pattern comprises at least a spiral pattern.

Example 6. The method of examples 1-5, wherein the predetermined pattern comprises concentric circles overlayed on the spiral.

Example 7. The method of examples 1-6, wherein the second drilling round follows the first drilling round following a duration wherein a temperature at the first drilling location decreases below a threshold temperature.

Example 8. The method of examples 1-7 wherein the predetermined pattern is a hole between 0.001” and 0.02” in diameter.

Example 9. The method of examples 1-8, further comprising following the first drilling round, moving the laser in the x and y dimensions to a second drilling location; applying the laser to the surface of the substrate at the second drilling location for a subsequent drilling round comprising one or more drilling passes whereby the laser is moved in the x and y dimensions in the predetermined pattern; and returning the laser to the first drilling location.

Example 10. A system for drilling holes in a substrate, the system comprising a laser; an xy scan head configured to position the laser in x and y dimensions relative to the substrate; a 3rd axis adjustment device configured to adjust a focal plane of the laser relative to a surface of the substrate in a z dimension; and a storage machine holding instructions executable by a logic machine to: focus the laser relative to the surface of the substrate at a first drilling location in the substrate; apply the laser to the surface of the substrate for a first drilling round comprising one or more drilling passes whereby the laser is moved in the x and y dimensions in a predetermined pattern; using the 3rd axis adjustment device, adjust the focal plane of the laser relative to the surface of the substrate in the z dimension; and apply the laser to the surface of the substrate at the first drilling location for a second drilling round comprising one or more drilling passes whereby the laser is moved in the x and y dimensions in the predetermined pattern.

Example 11. The system of example 10, wherein the storage machine further holds instructions executable by the logic machine to iteratively adjust the focal plane of the laser towards an interior of the substrate in the z dimension and apply the laser to the surface of substrate at the first drilling location for additional drilling rounds.

Example 12. The system of examples 10-11, wherein the substrate is carbon fiber reinforced polymer and wherein the laser is a green laser.

Example 13. The system of examples 10-12, wherein the laser is a pulsed laser.

Example 14. The system of examples 10-13, wherein a pulse-width of the pulsed laser is less than 10 picoseconds.

Example 15. The system of examples 10-14, wherein the predetermined pattern is a spiral with concentric circles layered on top the spiral.

Example 16. The system of examples 10-15, wherein the second drilling round follows the first drilling round following a duration wherein a temperature at the first drilling location decreases below a threshold temperature.

Example 17. The system of examples 10-16, wherein the storage machine further holds instructions executable by the logic machine to following the first drilling round, move the laser in the x and y dimensions to a second drilling location; apply the laser to the surface of the substrate at the second drilling location for a subsequent drilling round comprising one or more drilling passes whereby the laser is moved in the x and y dimensions in the predetermined pattern; and return the laser to the first drilling location.

Example 18. The system of examples 10-17, wherein the predetermined pattern is a hole between 0.001” and 0.02” in diameter.

Example 19. A system for drilling holes in a carbon fiber reinforced polymer substrate, the system comprising a picosecond pulsed green laser; an xy scan head configured to position the pulsed green laser in the x and y dimensions relative to the carbon fiber reinforced polymer substrate; a 3rd axis adjustment device configured to adjust a focal plane of the laser relative to a surface of the carbon fiber reinforced polymer substrate in a z dimension; and a storage machine holding instructions executable by a logic machine to focus the laser relative to the surface of the carbon fiber reinforced polymer substrate at a first drilling location in the carbon fiber reinforced polymer substrate; apply the laser to the surface of the carbon fiber reinforced polymer substrate for a first drilling round comprising one or more drilling passes whereby the laser is moved in the x and y dimensions in a predetermined pattern; move the laser in the x and y dimensions to a second drilling location; apply the laser to the surface of the carbon fiber reinforced polymer substrate at the second drilling location for a subsequent drilling round comprising one or more drilling passes whereby the laser is moved in the x and y dimensions in the predetermined pattern; return the laser to the first drilling location; using the 3rd axis adjustment device, adjust the focal plane of the laser relative to the surface of the carbon fiber reinforced polymer substrate in the z dimension; following a duration wherein a temperature at the first drilling location decreases below a threshold temperature, apply the laser to the surface of the carbon fiber reinforced polymer substrate at the first drilling location for a second drilling round; move the laser in the x and y dimensions to the second drilling location; and apply the laser to the surface of the carbon fiber reinforced polymer substrate for an additional drilling round comprising one or more drilling passes whereby the laser is moved in the x and y dimensions in the predetermined pattern.

Example 20. The system of example 19, wherein the picosecond pulsed green laser comprises two or more apertures, such that the first drilling location and the second drilling location comprise two or more drilling sites on the carbon fiber reinforced polymer substrate.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for drilling holes in a substrate, comprising:
focusing a laser relative to a surface of the substrate at a first drilling location in the substrate;
applying the laser to the surface of the substrate for a first drilling round, the first drilling round comprising one or more drilling passes wherein the laser is moved in x and y dimensions in a predetermined pattern;
adjusting a focal plane of the laser relative to the surface of the substrate in a z dimension; and
applying the laser to the surface of the substrate at the first drilling location for a second drilling round, the second drilling round comprising one or more drilling passes wherein the laser is moved in x and y dimensions in the predetermined pattern.

2. The method of claim 1, further comprising:
iteratively adjusting the focal plane of the laser relative to the surface of the substrate in the z dimension and applying the laser to the surface of substrate at the first drilling location for additional drilling rounds.

3. The method of claim 1, wherein the substrate comprises carbon fiber reinforced polymer and wherein the laser is a green laser.

4. The method of claim 3, wherein the laser is a pulsed laser with a pulse-width of less than 10 picoseconds.

5. The method of claim 1, wherein the predetermined pattern comprises at least a spiral pattern.

6. The method of claim 5, wherein the predetermined pattern comprises concentric circles overlayed on the spiral.

7. The method of claim 1, wherein the second drilling round follows the first drilling round following a duration wherein a temperature at the first drilling location decreases below a threshold temperature.

8. The method of claim 1, wherein the predetermined pattern is a hole between 0.001” and 0.02” in diameter.

9. The method of claim 8, further comprising:
following the first drilling round, moving the laser in the x and y dimensions to a second drilling location;
applying the laser to the surface of the substrate at the second drilling location for a subsequent drilling round comprising one or more drilling passes whereby the laser is moved in the x and y dimensions in the predetermined pattern; and
returning the laser to the first drilling location.

10. A system for drilling holes in a substrate, comprising:
a laser;
an xy scan head configured to position the laser in x and y dimensions relative to the substrate;
a 3rd axis adjustment device configured to adjust a focal plane of the laser relative to a surface of the substrate in a z dimension; and
a storage machine holding instructions executable by a logic machine to:
focus the laser relative to the surface of the substrate at a first drilling location in the substrate;
apply the laser to the surface of the substrate for a first drilling round comprising one or more drilling passes whereby the laser is moved in the x and y dimensions in a predetermined pattern;
using the 3rd axis adjustment device, adjust the focal plane of the laser relative to the surface of the substrate in the z dimension; and
apply the laser to the surface of the substrate at the first drilling location for a second drilling round comprising one or more drilling passes whereby the laser is moved in the x and y dimensions in the predetermined pattern.

11. The system of claim 10, wherein the storage machine further holds instructions executable by the logic machine to:
iteratively adjust the focal plane of the laser towards an interior of the substrate in the z dimension and apply the laser to the surface of substrate at the first drilling location for additional drilling rounds.

12. The system of claim 10, wherein the substrate is carbon fiber reinforced polymer and wherein the laser is a green laser.

13. The system of claim 10, wherein the laser is a pulsed laser.

14. The system of claim 13, wherein a pulse-width of the pulsed laser is less than 10 picoseconds.

15. The system of claim 10, wherein the predetermined pattern is a spiral with concentric circles layered on top the spiral.

16. The system of claim 10, wherein the second drilling round follows the first drilling round following a duration wherein a temperature at the first drilling location decreases below a threshold temperature.

17. The system of claim 16, wherein the storage machine further holds instructions executable by the logic machine to:
following the first drilling round, move the laser in the x and y dimensions to a second drilling location;
apply the laser to the surface of the substrate at the second drilling location for a subsequent drilling round comprising one or more drilling passes whereby the laser is moved in the x and y dimensions in the predetermined pattern; and
return the laser to the first drilling location.

18. The system of claim 10, wherein the predetermined pattern is a hole between 0.001” and 0.02” in diameter.

19. A system for drilling holes in a carbon fiber reinforced polymer substrate, comprising:
a picosecond pulsed green laser;
an xy scan head configured to position the pulsed green laser in the x and y dimensions relative to the carbon fiber reinforced polymer substrate;
a 3rd axis adjustment device configured to adjust a focal plane of the laser relative to a surface of the carbon fiber reinforced polymer substrate in a z dimension; and
a storage machine holding instructions executable by a logic machine to:
focus the laser relative to the surface of the carbon fiber reinforced polymer substrate at a first drilling location in the carbon fiber reinforced polymer substrate;
apply the laser to the surface of the carbon fiber reinforced polymer substrate for a first drilling round comprising one or more drilling passes whereby the laser is moved in the x and y dimensions in a predetermined pattern;
move the laser in the x and y dimensions to a second drilling location;
apply the laser to the surface of the carbon fiber reinforced polymer substrate at the second drilling location for a subsequent drilling round comprising one or more drilling passes whereby the laser is moved in the x and y dimensions in the predetermined pattern;
return the laser to the first drilling location;
using the 3rd axis adjustment device, adjust the focal plane of the laser relative to the surface of the carbon fiber reinforced polymer substrate in the z dimension;
following a duration wherein a temperature at the first drilling location decreases below a threshold temperature, apply the laser to the surface of the carbon fiber reinforced polymer substrate at the first drilling location for a second drilling round;
move the laser in the x and y dimensions to the second drilling location; and
apply the laser to the surface of the carbon fiber reinforced polymer substrate for an additional drilling round comprising one or more drilling passes whereby the laser is moved in the x and y dimensions in the predetermined pattern.

20. The system of claim 19, wherein the picosecond pulsed green laser comprises two or more apertures, such that the first drilling location and the second drilling location comprise two or more drilling sites on the carbon fiber reinforced polymer substrate.
